(19) United States
(12) Patent Application Publication
(10) Pub. No.: US 2022/0247897 A1
(43) Pub. Date: Aug. 4, 2022

(54) CAMERA MODULE

(71) Applicant: SAMSUNG ELECTRO-MECHANICS CO., LTD., Suwon-si (KR)

(72) Inventors: Tae Ho YUN, Suwon-si (KR); Sang Jong LEE, Suwon-si (KR)

(73) Assignee: SAMSUNG ELECTRO-MECHANICS CO., LTD., Suwon-si (KR)

(21) Appl. No.: 17/508,157

(22) Filed: Oct. 22, 2021

(30) Foreign Application Priority Data
Feb. 4, 2021 (KR) 10-2021-0016238

(51) Int. Cl. H04N 5/225; G03B 5/02; G02B 7/09; G03B 3/10

(52) U.S. Cl. CPC H04N 5/2253; G03B 5/02; G03B 2205/0069; G02B 7/09; G03B 3/10; H04N 5/2254

(57) ABSTRACT

A camera module includes: a lens module including one or more lenses disposed along an optical axis; a driving magnet disposed on the lens module and extending along the optical axis; and a driving coil configured to receive the driving magnet therein, and to interact with the driving magnet to drive the lens module in an optical axis direction.

### CROSS-REFERENCE TO RELATED APPLICATIONS

This application claims the benefit under 35 U.S.C. § 119(a) of Korean Patent Application No. 10-2021-0016238 filed on Feb. 4, 2021 in the Korean Intellectual Property Office, the entire disclosure of which is incorporated herein by reference for all purposes.

### BACKGROUND

### 1. Field

The following description relates to a camera module. For example, the following description relates to a camera module including a lens module with increased linear mobility.

### 2. Description of Related Art

A camera module includes a lens module, and may drive the lens module in an optical axis direction to adjust the focus of the camera module in an autofocusing (AF) function or adjust a focus magnification of the camera module in a zoom function.

The camera module may include a driving unit and a guide unit configured to driver the lens module in the optical axis direction. For example, the driving unit may include a driving magnet and a driving coil, and the guide unit may include a ball bearing.

However, the lens module of the camera module of the above-described type may have a small movement displacement width through the driving unit, and it may be difficult to reduce or suppress a rattling phenomenon (tilt phenomenon) and noise phenomenon of the lens module due to a manufacturing error of the ball bearing. Therefore, it is difficult to implement a telephoto camera having a long focal length or a zoom camera having a focal magnification of 4 or more.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

In one general aspect, a camera module includes: a lens module including one or more lenses disposed along an optical axis; a driving magnet disposed on the lens module and extending along the optical axis; and a driving coil configured to receive the driving magnet therein, and to interact with the driving magnet to drive the lens module in an optical axis direction.

The lens module may further include a coupling unit configured to be coupled to the driving magnet.

The coupling unit includes: a first coupling portion coupled to one end of the driving magnet; and a second coupling portion coupled to another end of the driving magnet.

A length of the driving magnet in the optical axis direction may be greater than a length of the driving coil in the optical axis direction.

The driving magnet may be configured in a form of a rod.

A first polarity and a second polarity may be alternately formed in the driving magnet, along the optical axis direction.

The camera module may further include an oilless bearing configured to reduce friction between the driving magnet and the coil member.

The driving coil may include: a first coil bundle configured to interact with a first portion of the driving magnet through a first current signal; and a second coil bundle disposed adjacent to the first coil bundle and configured to interact with a second portion of the driving magnet through a second current signal.

The driving coil may include: a first coil bundle configured to interact with a first region of the driving magnet through a first current signal to generate driving force in a first direction; and a second coil bundle disposed adjacent to the first coil bundle, and configured to interact with a second region of the driving magnet by the first current signal to generate driving force in the first direction.

The driving coil may include: a first coil bundle configured to interact with a first portion of the driving magnet through a first current signal; a second coil bundle disposed adjacent to the first coil bundle and configured to interact with a second portion of the driving magnet through a second current signal; and a third coil bundle disposed adjacent to the second coil bundle and configured to interact with a third portion of the driving magnet by a third current signal.

The driving magnet may include a plurality of driving magnets and the driving coil may include a plurality of driving coils. The plurality of driving magnets and the plurality of driving coils may be disposed in a circularly symmetrical shape with respect to the optical axis.

The camera module may further include a coil support member configured to fix the driving coil to a housing.

The camera module may further include an optical path changing unit disposed on an object side of the lens module and configured to change an optical path of incident light.

In another general aspect, a camera module includes: a lens module including one or more lenses; a driving magnet having a rod shape, coupled to the lens module, and having a first polarity and a second polarity alternately formed in an optical axis direction; and a driving coil disposed to face a circumferential surface of the driving magnet at a predetermined distance, and configured to provide driving force to drive the lens module through interacting with the driving magnet.

The camera module may further include an optical path changing unit disposed on an object side of the lens module.

The driving coil may include coil bundles disposed adjacent to each other in the optical axis direction, and configured to respectively interact with different portions of the driving magnet.

The driving coil may have a trough shape having a radius of curvature substantially the same as a shape of the circumferential surface of the driving magnet.

Other features and aspects will be apparent from the following detailed description, the drawings, and the claims.

### BRIEF DESCRIPTION OF DRAWINGS

FIG. 1 is an exploded perspective view of a camera module, according to an example.

FIG. 2 is a perspective view illustrating partial coupling of the camera module illustrated in FIG. 1.

FIGS. 3 and 4 are cross-sectional views of the camera module configured as illustrated in FIG. 2.

FIG. 5 is an operation state diagram of the camera module configured as illustrated in FIG. 4.

FIG. 6 is an exploded perspective view of a camera module, according to an example.

FIG. 7 is a perspective view illustrating partial coupling of the camera module illustrated in FIG. 6.

FIGS. 8 and 9 are cross-sectional views of the camera module configured as illustrated in FIG. 7.

FIG. 10 is an operation state diagram of the camera module configured as illustrated in FIG. 9.

FIG. 11 is an exploded perspective view of a camera module, according to an example.

FIG. 12 is a combined perspective view of a main configuration of the camera module illustrated in FIG. 11.

FIGS. 13 and 14 are cross-sectional views of a lens module illustrated in FIG. 11.

FIG. 15 is a combined perspective view of the camera module illustrated in FIG. 11.

Throughout the drawings and the detailed description, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Herein, it is to be noted that use of the term “may” with respect to an embodiment or example, e.g., as to what an embodiment or example may include or implement, means that at least one embodiment or example exists in which such a feature is included or implemented while all examples and examples are not limited thereto.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper,” “below,” and “lower” may be used herein for ease of description to describe one element's relationship to another element as illustrated in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes illustrated in the drawings may occur. Thus, the examples described herein are not limited to the specific shapes illustrated in the drawings, but include changes in shape occurring during manufacturing.

The features of the examples described herein may be combined in various manners as will be apparent after gaining an understanding of the disclosure of this application. Further, although the examples described herein have a variety of configurations, other configurations are possible as will be apparent after gaining an understanding of the disclosure of this application.

A camera module according to an example may include a lens module and a driving unit configured to drive the lens module. The lens module may accommodate one or more lenses. For example, one or more lenses may be sequentially disposed in the lens module in an optical axis direction. For example, the driving unit may move the lens module in the optical axis direction. The driving unit may include a driving magnet and a driving coil. However, the configuration of the driving unit is not limited to the driving magnet and the driving coil.

The driving magnet may be disposed on the lens module. For example, the driving magnet may be disposed on at least one side of the lens module. The driving magnet may extend along an optical axis. For example, the driving magnet may be configured in the form of a rod extending lengthwise in the optical axis direction. However, the shape of the driving magnet is not limited to a rod shape. The driving magnet may be configured such that the first polarity and the second polarity are alternately formed. For example, the N pole and the S pole of the driving magnet may be alternately formed in a predetermined number in the optical axis direction. The driving magnet may be formed to have a substantial length. For example, the length of the driving magnet in the optical axis direction may be greater than a maximum movement displacement of the lens module in the optical axis direction. As another example, the length of the driving magnet in the optical axis direction may be greater than a length of the driving coil in the optical axis direction.

The driving coil may be formed to accommodate the driving magnet therein. For example, the driving coil may have a substantially cylindrical shape to accommodate the driving magnet inside thereof. The driving coil may provide driving force necessary for driving the lens module. For example, the driving coil may interact with the driving magnet to provide driving force necessary to move the lens module in the optical axis direction. The driving coil may be formed of a plurality of coil bundles. For example, the driving coil may include a first coil bundle and a second coil bundle configured to interact with the driving magnet by an independent current signal, respectively. However, the number of coil bundles constituting the driving coil is not limited to three. For example, the driving coil may include three or more coil bundles.

A camera module according to another example may include a configuration substantially similar to that of the example described above. For example, a camera module according to another example may include a lens module and a driving unit like the camera module according to the example described above. The lens module may include one or more lenses, and the driving unit may include a driving magnet and a driving coil.

The driving unit of the camera module according to the other example may be configured such that the driving magnet and the driving coil face each other. For example, the driving magnet may be formed to have a substantially rod shape, and the driving coil may be formed to face the circumferential surface of the driving magnet at a predetermined distance. In the camera module according to the other example, the driving magnet and the driving coil may provide driving force necessary to drive the lens module in the optical axis direction.

In the camera module according to the examples described above, an area in which the driving magnet and the driving coil face each other may be provided with a significant size. For example, the driving magnet and the driving coil may be disposed or formed to face each other by a substantial length in the optical axis direction. Therefore, the camera module according to the examples described above may move the lens module by a significant amount in the optical axis direction, and may greatly adjust the focus magnification through driving the lens module.

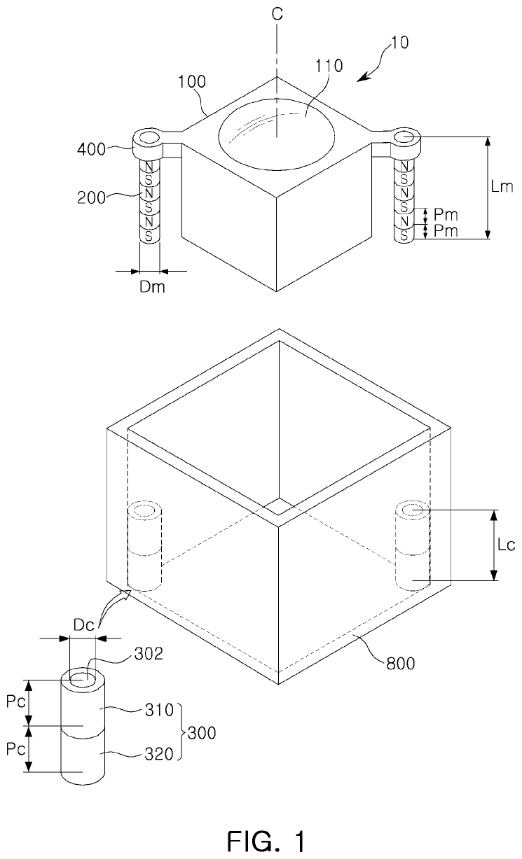

First, a camera module, according to an example, will be described with reference to FIGS. 1 to 5.

Referring to FIGS. 1 to 5, a camera module 10 according to an example includes a lens module 100 and a driving unit. However, the configuration of the camera module 10 is not limited to the lens module 100 and the driving unit. For example, the camera module 10 may further include a housing 800 accommodating the lens module 100. In addition, the camera module 10 may further include an image sensor (not illustrated) for converting an optical signal (e.g., light) incident through the lens module 100 into an electrical signal. In addition, the camera module 10 may further include an optical path changing unit (not illustrated) disposed on an object side of the lens module 100 and/or on an image plane side of the lens module 100. As an example, the camera module 10 may further include a prism or mirror type optical path changing unit disposed on the object side of the lens module 100 to convert an optical path of the incident light.

The lens module 100 may include a configuration configured to form an image of light incident in the camera module 10 on the image sensor. For example, the lens module 100 may include one or more lenses 110 disposed along an optical axis C. For reference, although FIGS. 1 to 5 illustrate an example in which only one lens 110 is illustrated, the lens module 100 may include a plurality of lenses. For example, the lens module 100 may include four or more lenses disposed along the optical axis (C). However, the number of lenses included in the lens module 100 is not limited to four or more. For example, the lens module 100 may also include three or fewer lenses, or five or more lenses.

The driving unit is configured to move the lens module 100 in the optical axis (C) direction. The driving unit may include a driving magnet 200 and a driving coil 300. The driving magnet 200 may be disposed on the lens module 100. For example, the driving magnet 200 may be mounted on one end of the lens module 100 by a coupling unit 400. For reference, although the two driving magnets 200 are illustrated to be disposed on different diagonal positions of the lens module 100 in FIG. 1, the arrangement positions and the number of the driving magnets 200 are not limited to the form illustrated in FIG. 1. For example, the two driving magnets 200 may also be disposed side-by-side on one side of the lens module 100. As another example, four driving magnets 200 may be disposed at four corners of the lens module 100, respectively. As another example, a plurality of driving magnets 200 may also be disposed in a circularly symmetrical shape with respect to the optical axis C.

The driving magnet 200 may be formed to be elongated in one direction. For example, the driving magnet 200 may be formed to be elongated along the optical axis C. The driving magnet 200 may be configured such that a first polarity and a second polarity are alternately formed. For example, the N pole and the S pole of the driving magnet 200 may be formed to be repeated in alternating order two or more times along the optical axis C. The lengths of the first polarity and the second polarity constituting the driving magnet 200 may be substantially the same. For example, in the driving magnet 200, a length Pm of the N pole may be substantially the same as a length Pm of the S pole. The driving magnet 200 may be formed to have a substantially rod shape elongated in a direction of the optical axis C. However, the shape of the driving magnet 200 is not limited to a rod shape. The driving magnet 200 may have predetermined diameter Dm and length Lm.

The driving coil 300 may be configured to accommodate the driving magnet 200. For example, the driving coil 300 may be formed to have a cylindrical shape elongated in a direction of the optical axis C, to accommodate the rod-shaped driving magnet 200 in an inner space 302. However, the shape of the driving coil 300 is not limited to a cylindrical shape. The driving coil 300 may be disposed to mate with the driving magnet 200. For example, the driving coil 300 may be configured in the same number as that of the driving magnets 200, and may be disposed in the same manner as the driving magnet 200. For example, when a number of driving magnets 200 are circularly disposed around the optical axis C, the same number of driving coils 300 may be circularly disposed around the optical axis C.

The driving coil 300 may include a plurality of coil bundles interacting with the driving magnet 200 by different current signals. For example, the driving coil 300 may include a first coil bundle 310 configured to interact with a portion of the driving magnet 200 through a first current signal, and a second coil bundle 320 configured to interact with a portion of the driving magnet 200 through a second current signal. As another example, the driving coil 300 may include the first coil bundle 310 configured to interact with a first region (e.g., the N pole) of the driving magnet 200 by the first current signal to generate driving force in the first direction, and the second coil bundle 320 configured to interact with a second region (e.g., the S pole) of the driving magnet 200 by the first current signal to generate driving force in the first direction. The first coil bundle 310 and the second coil bundle 320 may be disposed in sequence in the optical axis (C) direction. The first coil bundle 310 and the second coil bundle 320 may be formed to have substantially the same length and size. For example, a length Pc of the first coil bundle 310 and a length Pc of the second coil bundle 320 may be substantially the same.

The driving coil 300 may have a predetermined size relationship with the driving magnet 200. For example, an inner diameter Dc of the driving coil 300 may be substantially greater than the diameter Dm of the driving magnet 200. As another example, a length Lc of the driving coil 300 may be less than the length Lm of the driving magnet 200. As another example, the length Pc of the coil bundles 310 and 320 of the driving coil 300 may be substantially greater than the length Pm of one polarity (N pole or S pole) of the driving magnet 200.

An element for reducing friction between the driving magnet 200 and the driving coil 300 may be disposed in a space between the driving coil 300 and the driving magnet 200. For example, a lubricant may be injected or an oilless bearing may be disposed between the driving coil 300 and the driving magnet 200.

The driving coil 300 may be disposed on a fixed member, unlike the driving magnet 200, which is disposed on a movable member. For example, the driving coil 300 may be disposed in the housing 800 accommodating the lens module 100 therein.

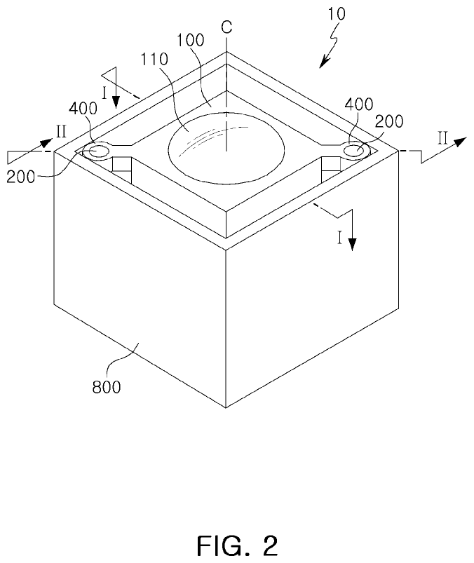

The camera module 10 configured as above may be configured in a form in which the lens module 100 is accommodated in the housing 800 as illustrated in FIG. 2. For reference, according to FIG. 2, the lens module 100 is completely accommodated in the housing 800. However, in another example, the camera module 10 may be configured such that only a part of the lens module 100 is accommodated in the housing 800.

The camera module 10 may drive the lens module 100 in the optical axis (C) direction through the interaction between the driving magnet 200 and the driving coil 300. For example, the lens module 100 may move in the vertical direction by the interaction between the coil bundles 310 and 320 of the driving coil 300 and the driving magnet 200 located inside of the coil bundles 310 and 320.

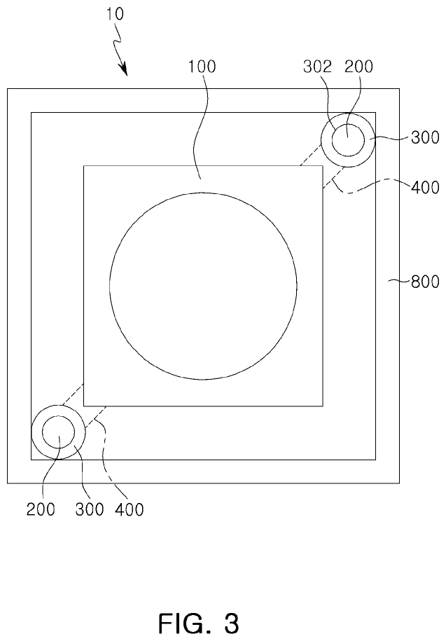

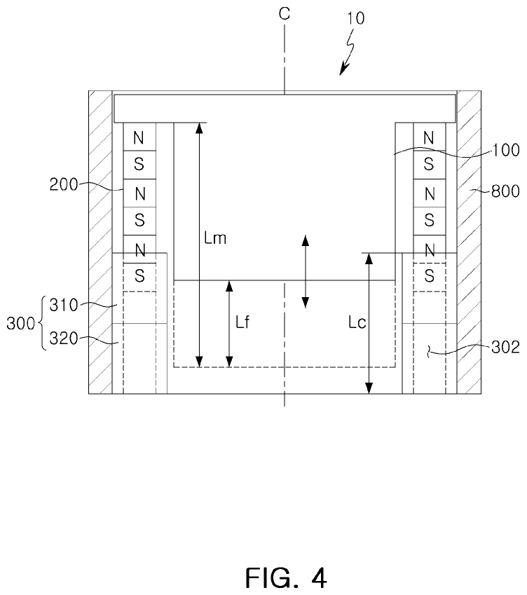

The driving magnet 200 and the driving coil 300 configured as the driving unit of the camera module 10 may be disposed in the form illustrated in FIGS. 3 and 4. For example, the driving magnet 200 may be disposed in an inner space 302 of the driving coil 300. The driving magnet 200 is formed to be elongated in the optical axis (C) direction. The length Lm of the driving magnet 200 may be greater than the length Lc of the driving coil 300 and greater than a maximum movement displacement Lf of the lens module 100. The maximum movement displacement Lf is a maximum distance by which the lens module 100 may be moved in the optical axis (C) direction by the driving unit. The length Lm of the driving magnet 200 and the length Lc of the driving coil 300 may have a predetermined magnitude relationship with the movement displacement Lf of the lens module 100. For example, a deviation (|Lm−Lc|) between the length Lm of the driving magnet 200 and the length Lc of the driving coil 300 may be equal to the maximum movement displacement Lf of the lens module 100 or may be greater than the maximum movement displacement Lf.

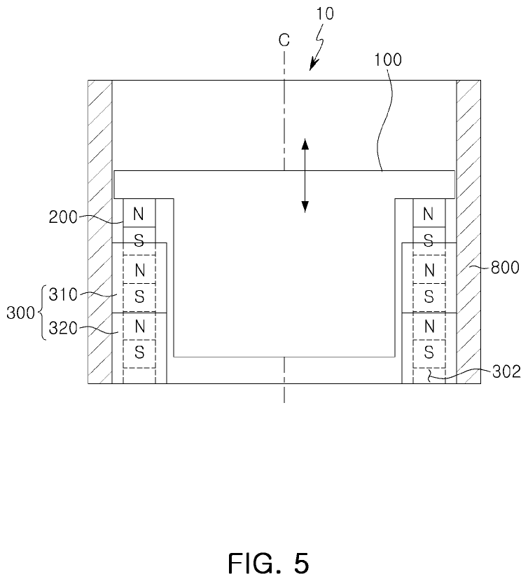

The areas facing each other, between the driving magnet 200 and the driving coil 300, or the driving force acting between the driving magnet 200 and the driving coil 300, may be maintained substantially constant. For example, the area where the driving magnet 200 and the driving coil 300 face each other, or the driving force acting between the driving magnet 200 and the driving coil 300 may be substantially constant regardless of the position of the lens module 100. For example, the magnitude of the driving force acting between the driving magnet 200 and the driving coil 300 in a state in which the lens module 100 is positioned upwardly (refer to FIG. 4) may be substantially equal to the magnitude of the driving force acting between the driving magnet 200 and the driving coil 300 in the state in which the lens module 100 is positioned downwardly (refer to FIG. 5).

Accordingly, in the camera module 10, the movement precision of the lens module 100 may be improved. For example, since the interaction between the driving coil 300 and the driving magnet 200, when the driving magnet 200 is moving in the inner space 302 of the driving coil 300, occurs at a constant magnitude, the movement displacement of the lens module 100 may be precisely adjusted by the current signal or the amount of current supplied to the driving coil 300 regardless of the position of the lens module 100.

Next, an operation example of the camera module 10, according to an embodiment, will be described with reference to FIGS. 4 and 5.

The camera module 10 may fix the position of the lens module 100 or change the position of the lens module 100 through the interaction between the driving magnet 200 and the driving coil 300. For example, when a separate current signal is not applied to the driving coil 300, the position of the lens module 100 may be maintained in the current state by the attractive force between the driving magnet 200 and the driving coil 300. As another example, when a predetermined current signal is applied to the driving coil 300, the lens module 100 may be moved upwardly or downward by the interaction between the driving magnet 200 and the driving coil 300. The movement of the lens module 100 may be continued while the current signal is applied to the driving coil 300. For example, the driving coil 300 continuously interacts with the driving magnet 200 carried into the inner space 302 of the driving coil 300, while the current signal is applied to the driving coil 300, thereby providing driving force necessary for the movement of the lens module 100.

The camera module 10 configured as described above may increase the maximum movement displacement of the lens module 100. In detail, since the interaction between the driving magnet 200 and the driving coil 300 in the camera module 10 may be sequentially formed over the entire length Lm of the driving magnet 200, the maximum movement displacement Lf of the lens module 100 may be extended to have substantially the same magnitude as the length Lm of the driving magnet 200. Accordingly, in the camera module 10, the maximum movement displacement of the lens module 100 may be significantly increased to enable focus magnification adjustment (zoom) as well as autofocusing (AF).

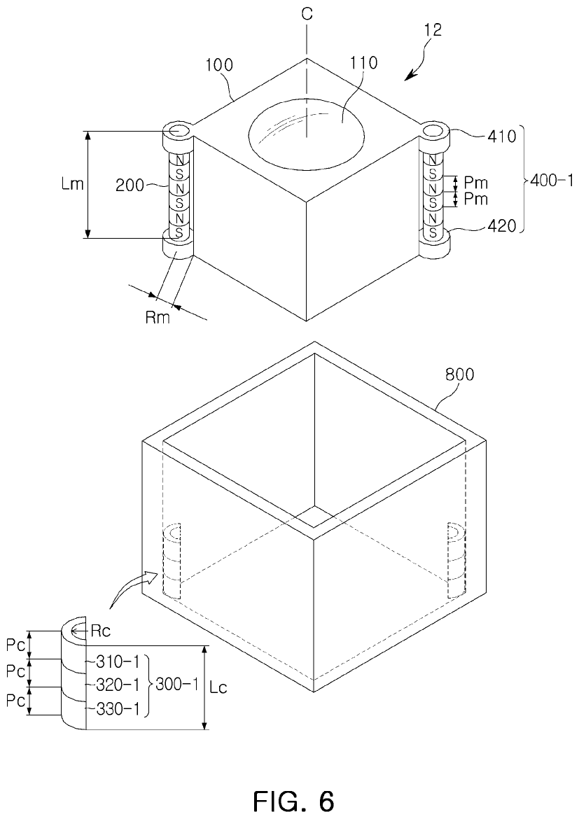

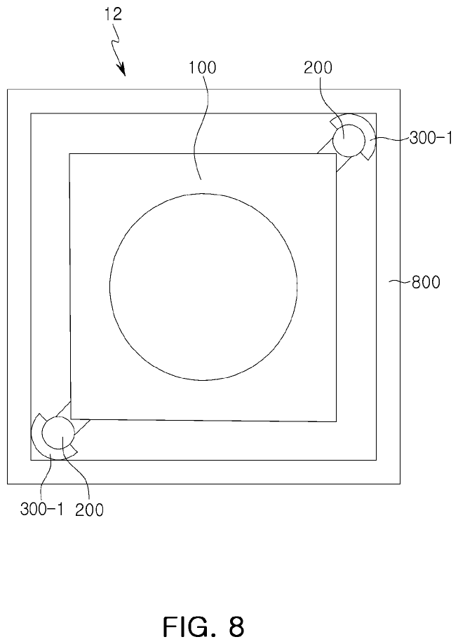

Next, a camera module, according to an example, will be described with reference to FIGS. 6 to 10.

Referring to FIGS. 6 to 10, a camera module 12 includes the lens module 100 and a driving unit. However, the configuration of the camera module 12 is not limited to the lens module 100 and the driving unit. For example, the camera module 12 may further include the housing 800 accommodating the lens module 100. In addition, the camera module 12 may further include an image sensor (not illustrated) configured to convert an optical signal (e.g., light) incident through the lens module 100 into an electrical signal. In addition, the camera module 12 may further include an optical path changing unit (not illustrated) disposed on the object side of the lens module 100 and/or on the image plane side of the lens module 100. For example, the camera module 12 may further include a prism or mirror-type optical path changing unit disposed on the object side of the lens module 100 to convert the optical path of the incident light.

The lens module 100 may include a configuration for configured to form an image of light incident in the camera module 12 on the image sensor. For example, the lens module 100 may include one or more lenses 110 disposed along the optical axis C. For reference, although only one lens 110 is illustrated in FIGS. 6 to 10, the lens module 100 may include a plurality of lenses. For example, the lens module 100 may include four or more lenses disposed along the optical axis C. However, the number of lenses included in the lens module 100 is not limited to four. For example, the lens module 100 may include three or fewer lenses, or five or more lenses.

The driving unit is configured to move the lens module 100 in the optical axis (C) direction. The driving unit may include the driving magnet 200 and a driving coil 300-1. The driving magnet 200 may be disposed on the lens module 100. For example, the driving magnet 200 may be mounted at different corners of the lens module 100 by a coupling unit 400-1 (410, 420). The coupling unit 400-1 may include a first coupling portion 410 and a second coupling portion 420. The first coupling portion 410 may be formed on an upper portion of the lens module 100 and coupled to one end of the driving magnet 200. The second coupling portion 420 may be formed on a lower portion of the lens module 100 and coupled to the other end of the driving magnet 200. The coupling unit 400-1 may be firmly coupled to the driving magnet 200. For example, the coupling unit 400-1 may be firmly coupled to the driving magnet 200 by an adhesive or other fastening member or fastening unit. For reference, although the two driving magnets 200 are illustrated to be disposed at different diagonal positions of the lens module 100 in FIG. 6, the arrangement positions and the number of the driving magnets 200 are not limited to the form illustrated in FIG. 6. For example, the two driving magnets 200 may be disposed side-by-side on one side of the lens module 100. As another example, the four driving magnets 200 may be disposed at four corners of the lens module 100, respectively. As another example, the plurality of driving magnets 200 may be disposed in a circularly symmetrical shape with respect to the optical axis C.

The driving magnet 200 may be formed to be elongated in one direction. For example, the driving magnet 200 may be formed to be elongated along the optical axis (C). The driving magnet 200 may be configured such that the first polarity and the second polarity are alternately formed. For example, the N pole and the S pole of the driving magnet 200 may be formed to be repeated in alternating order two or more times along the optical axis C. The lengths of the first polarity and the second polarity constituting the driving magnet 200 may be substantially the same. For example, in the driving magnet 200, a length Pm of the N pole may be substantially the same as a length Pm of the S pole. The driving magnet 200 may be formed in a substantially rod shape elongated in a direction of the optical axis C. However, the shape of the driving magnet 200 is not limited to a rod shape. The driving magnet 200 may have a predetermined radius Rm and a length Lm.

The driving coil 300-1 may be configured to contact or face the circumferential surface of the driving magnet 200. For example, the driving coil 300-1 may be formed to have a trough shape having a radius of curvature substantially the same as or similar to that of the circumferential surface of the driving magnet 200, to be in close contact with the circumferential surface of the driving magnet 200. However, the shape of the driving coil 300-1 is not limited to the trough shape. The driving coil 300-1 may be disposed to mate with the driving magnet 200. For example, the driving coil 300-1 may be configured in the same number as the driving magnet 200, and may be disposed in the same manner as the driving magnet 200. For example, when a number of driving magnets 200 are circularly disposed around the optical axis C, the same number of driving coils 300-1 may be circularly disposed around the optical axis C.

The driving coil 300-1 may include a plurality of coil bundles configured to interact with the driving magnet 200 by different current signals. For example, the driving coil 300-1 may include a first coil bundle 310-1 configured to interact with a portion of the driving magnet 200 through a first current signal, a second coil bundle 320-1 configured to interact with a portion of the driving magnet 200 through a second current signal, and a third coil bundle 330-1 configured to interact with a portion of the driving magnet 200 by the first current signal or a third current signal. As another example, the driving coil 300-1 may include the first coil bundle 310-1 configured to interact with a first region (e.g., the N pole) of the driving magnet 200 by the first current signal to generate driving force in the first direction, the second coil bundle 320-1 configured to interact with a second region (e.g., the S pole) of the driving magnet 200 by the first current signal to generate driving force in the first direction, and the third coil bundle 330-1 configured to interact with a third region (e.g., different N pole) of the driving magnet 200 by the first current signal to generate driving force in the first direction. The first coil bundle 310-1 to the third coil bundle 330-1 may be disposed in the optical axis (C) direction. The first coil bundle 310-1 to the third coil bundle 330-1 may be formed to have substantially the same length and size. For example, the length of the first coil bundle 310-1, the length of the second coil bundle 320-1, and the length of the third coil bundle 330-1 may all have the same size (Pc).

The driving coil 300-1 may have a predetermined size relationship with the driving magnet 200. For example, an inner radius Rc of the driving coil 300-1 may be substantially greater than a radius Rm of the driving magnet 200. As another example, the length Lc of the driving coil 300-1 may be less than the length Lm of the driving magnet 200. As another example, the length Pc of the coil bundles 310-1, 320-1, and 330-1 of the driving coil 300-1 may be substantially greater than the length Pm of one polarity (N pole or S pole) of the driving magnet 200.

An element for reducing friction between the driving magnet 200 and the driving coil 300 may be disposed in a space between the driving coil 300-1 and the driving magnet 200. For example, a lubricant may be injected or an oilless bearing may be disposed between the driving coil 300-1 and the driving magnet 200.

The driving coil 300-1 may be disposed on a fixed member, unlike the driving magnet 200, which is disposed on the movable member. For example, the driving coil 300-1 may be disposed in the housing 800 accommodating the lens module 100 therein.

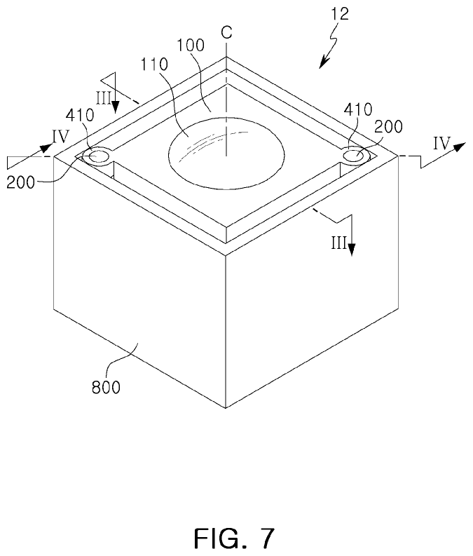

The camera module 12 configured as described above may be configured in a form in which the lens module 100 is accommodated in the housing 800 as illustrated in FIG. 7. For reference, according to FIG. 7, the lens module 100 is completely accommodated in the housing 800. However, the camera module 12 may be configured in such a manner that only a part of the lens module 100 is accommodated in the housing 800.

The camera module 12 may drive the lens module 100 in the optical axis C direction through the interaction between the driving magnet 200 and the driving coil 300-1. For example, the lens module 100 may be vertically moved by the interaction between the coil bundles 310-1, 320-1 and 330-1 of the driving coil 300-1 and the driving magnet 200 located inside the coil bundles 310-1, 320-1 and 330-1.

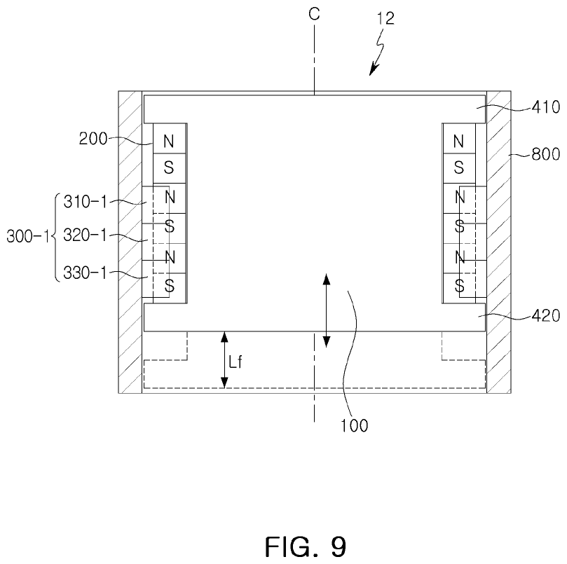

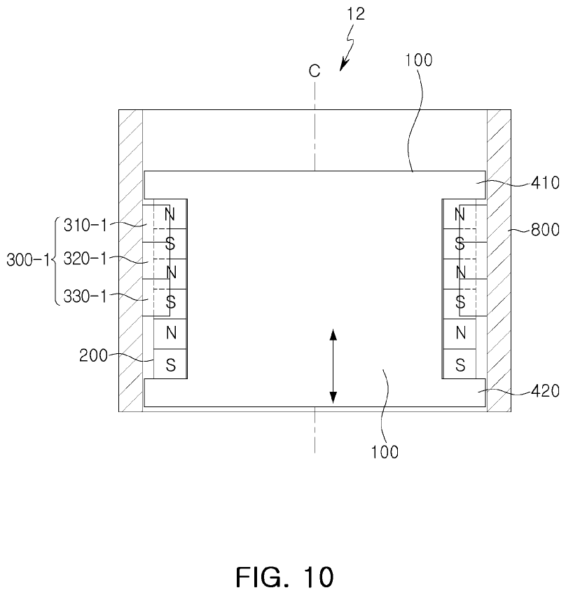

The driving magnet 200 and the driving coil 300-1 configured as the driving unit of the camera module 12 may be disposed in the form illustrated in FIGS. 9 and 10. In more detail, the driving magnet 200 may be disposed in the inner space 302 of the driving coil 300-1. The driving magnet 200 is formed to be elongated in the optical axis C direction. The length Lm of the driving magnet 200 may be greater than the length Lc of the driving coil 300-1 and greater than the maximum movement displacement Lf of the lens module 100. The length Lm of the driving magnet 200 and the length Lc of the driving coil 300-1 may have a predetermined magnitude relationship with the movement displacement Lf of the lens module 100. For example, a deviation (|Lm−Lc|) between the length Lm of the driving magnet 200 and the length Lc of the driving coil 300-1 may be equal to the maximum movement displacement Lf of the lens module 100 or may be greater than the maximum movement displacement Lf.

The areas facing each other between the driving magnet 200 and the driving coil 300-1, or the driving force acting between the driving magnet 200 and the driving coil 300-1, may be maintained substantially constant. For example, the area in which the driving magnet 200 and the driving coil 300-1 face each other or the driving force acting between the driving magnet 200 and the driving coil 300-1 may be substantially constant regardless of the position of the lens module 100. For example, the magnitude of the driving force acting between the driving magnet 200 and the driving coil 300-1 in a state in which the lens module 100 is positioned upwardly (refer to FIG. 9) may be substantially equal to the magnitude of the driving force acting between the driving magnet 200 and the driving coil 300-1 in a state in which the lens module 100 is positioned downwardly (refer to FIG. 10).

Accordingly, in the camera module 12, the movement precision of the lens module 100 may be improved. For example, since the interaction between the driving coil 300-1 and the driving magnet 200 moving the inner space 302 of the driving coil 300-1 occurs at a constant magnitude regardless of the position of the lens module 100, the movement displacement of the lens module 100 may be precisely adjusted by the current signal or the amount of current supplied to the driving coil 300-1.

In the camera module 12 configured as described above, since the driving magnet 200 is firmly fixed to the lens module 100 by a plurality of coupling portions 410 and 420, the mutual interaction between the driving magnet 200 and the driving coil 300 may enable stable movement of the lens module 100. In addition, since the driving coil 300-1 is in contact with a portion (circumferential surface) of the driving magnet 200, the sizes of the driving magnet 200 and the driving coil 300-1 may be reduced.

Next, an operation example of the camera module 12 will be described with reference to FIGS. 9 and 10.

The camera module 12 may fix the position of the lens module 100 or change the position of the lens module 100 through interaction between the driving magnet 200 and the driving coil 300-1. For example, when a separate current signal is not applied to the driving coil 300-1, the position of the lens module 100 may be maintained in the current state by the attractive force between the driving magnet 200 and the driving coil 300-1. As another example, when a predetermined current signal is applied to the driving coil 300-1, the lens module 100 may be moved upwardly or downwardly by the interaction between the driving magnet 200 and the driving coil 300-1. The movement of the lens module 100 may be continued while the current signal is applied to the driving coil 300-1. For example, the driving coil 300-1 may continuously interact with the driving magnet 200, when the driving magnet 200 is carried into the inner space 302 of the driving coil 300-1, while the current signal is applied to the driving coil 300-1, thereby providing driving force necessary for the movement of the lens module 100.

In the camera module 12 configured as above, the maximum movement displacement of the lens module 100 may be increased. In detail, since the interaction between the driving magnet 200 and the driving coil 300-1 in the camera module 12 may be sequentially formed over the entire length Lm of the driving magnet 200, the movement displacement Lf of the lens module 100 may be extended to have substantially the same magnitude as the length Lm of the driving magnet 200. Accordingly, in the camera module 12, the movement displacement of the lens module 100 may be significantly increased to enable focus magnification adjustment (zoom) as well as autofocusing (AF).

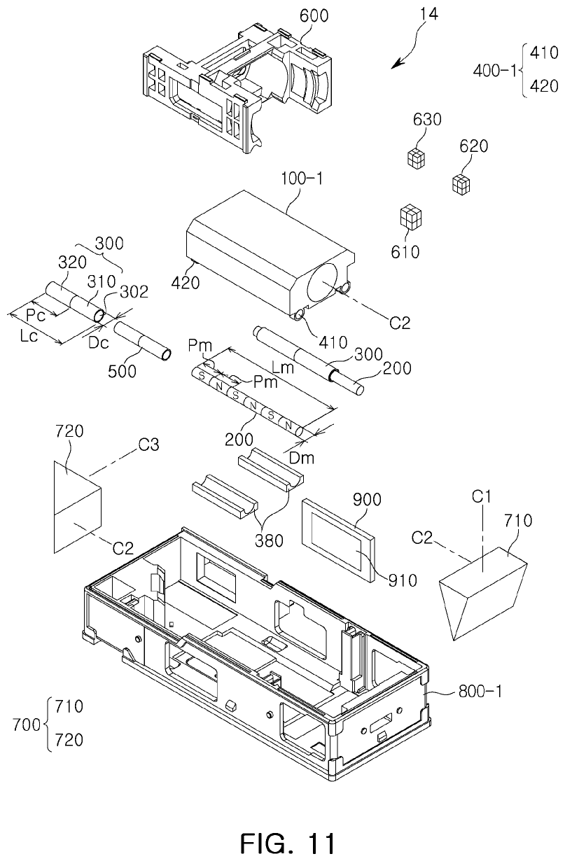

Next, a camera module, according to an example, will be described with reference to FIGS. 11 to 15.

Referring to FIGS. 11 to 15, a camera module 14, according to an example, includes a lens module 101, the driving magnet 200, and the driving coil 300. In addition, the camera module 14 may further include a coil support member 380, a bracket 600, an oilless bearing 500, and a housing 801. In addition, the camera module 14 may further include optical path changing units 710 and 720, a substrate 900, and an image sensor 910.

The lens module 101 may include a configuration configured to form an image of light incident in the camera module 14 on the image sensor 910. For example, the lens module 101 may include one or more lenses disposed along an optical axis C2. The lens module 101 may include a plurality of lenses. For example, the lens module 101 may include four or more lenses disposed along the optical axis C2. However, the number of lenses included in the lens module 101 is not limited to four. For example, the lens module 101 may include three or fewer lenses, or five or more lenses.

The driving unit is configured to move the lens module 101 in the direction of the optical axis C2. The driving unit may include the driving magnet 200 and the driving coil 300. The driving magnet 200 may be disposed on the lens module 100. The driving magnet 200 may be mounted on the lens module 101 by the coupling unit 400-1 (410, 420). For example, the driving magnet 200 may be mounted on one surface of the lens module 101 by the coupling unit 400-1 (410, 420). The coupling unit 400-1 may include the first coupling portion 410 and the second coupling portion 420. The first coupling portion 410 may be formed in front of the lens module 101 and coupled to one end of the driving magnet 200. The second coupling portion 420 may be formed on the rear of the lens module 101 and coupled to the other end of the driving magnet 200. The coupling unit 400-1 may be firmly coupled to the driving magnet 200. For example, the coupling unit 400-1 may be firmly coupled to the driving magnet 200 by an adhesive or other fastening member or fastening unit. The driving magnet 200 may include a plurality of driving magnets 200. For example, two driving magnets 200 may be disposed on the lens module 101 at a predetermined distance in a direction intersecting the optical axis C2.

The driving magnet 200 may be formed to be elongated in one direction. For example, the driving magnet 200 may be formed to be elongated along a direction of the optical axis C2. The driving magnet 200 may be configured such that the first polarity and the second polarity are alternately formed. For example, the N pole and the S pole of the driving magnet 200 may be formed to be repeated two or more times along a direction of the optical axis C2. The lengths of the first polarity and the second polarity constituting the driving magnet 200 may be substantially the same. For example, in the driving magnet 200, a length Pm of the N pole may be substantially the same as a length Pm of the S pole. The driving magnet 200 may be substantially formed in a rod shape. However, the shape of the driving magnet 200 is not limited to a rod shape. The driving magnet 200 may have predetermined diameter Dm and length Lm.

The driving coil 300 may be configured to accommodate the driving magnet 200. For example, the driving coil 300 may be formed in a cylindrical shape to accommodate the rod-shaped driving magnet 200 in the inner space 302 thereof. However, the shape of the driving coil 300 is not limited to a cylindrical shape. The driving coil 300 may be disposed to mate with the driving magnet 200. For example, the driving coil 300 may be configured in the same number as the driving magnet 200, and may be disposed in the same manner as the driving magnet 200.

The driving coil 300 may include a plurality of coil bundles interacting with the driving magnet by different current signals. For example, the driving coil 300 may include the first coil bundle 310 configured to interact with a portion of the driving magnet 200 by a first current signal, and the second coil bundle 300 configured to interact with a portion of the driving magnet 200 by a second current signal. As another example, the driving coil 300 may include the first coil bundle 310 configured to interact with a first region (e.g., the N pole) of the driving magnet 200 by the first current signal to generate driving force in the first direction, and the second coil bundle 320 configured to interact with a second region (e.g., the S pole) of the driving magnet 200 by the first current signal to generate driving force in the first direction. The first coil bundle 310 and the second coil bundle 320 may be disposed in sequence in the optical axis (C2) direction. The first coil bundle 310 and the second coil bundle 320 may be formed to have substantially the same length and size. For example, a length Pc of the first coil bundle 310 and a length Pc of the second coil bundle 320 may be substantially the same.

The driving coil 300 may have a predetermined size relationship with the driving magnet 200. For example, the inner diameter Dc of the driving coil 300 may be substantially greater than the diameter Dm of the driving magnet 200. As another example, the length Lc of the driving coil 300 may be less than the length Lm of the driving magnet 200. As another example, the length Pc of the coil bundles 310 and 320 of the driving coil 300 may be substantially greater than the length Pm of one polarity (N pole or S pole) of the driving magnet 200.

An element for reducing friction between the driving magnet 200 and the driving coil 300 may be disposed in a space between the driving coil 300 and the driving magnet 200. For example, the oilless bearing 500 may be disposed between the driving coil 300 and the driving magnet 200. The oilless bearing 500 may be configured in a substantially cylindrical shape. However, the shape of the oilless bearing 500 is not limited to a cylindrical shape.

The driving coil 300 may be fixed to a member other than the lens module 101. For example, the driving coil 300 may be fixed to the bracket 600 or the housing 801. A structure for supporting the cylindrical driving coil 300 may be disposed on the bracket 600 or the housing 801. For example, the coil support member 380 may have a substantially trough shape, and may be disposed on the bracket 600 or the housing 801. The driving coil 300 may be fixed to the coil support member 380. For example, the driving coil 300 may be firmly fixed to the coil support member 380 by an adhesive member.

An optical path changing unit 700 including the first optical path changing unit 710 and the second optical path changing unit 720 is located on the object side of the lens module 101 or on the image plane side of the lens module 101. The optical path changing unit 700 is configured to refract or change the optical path of light incident to the camera module 14. For example, the first optical path changing unit 710 may refract the path of light incident along a first optical axis C1 in the second optical axis (C2) direction, and the second optical path changing unit 720 may refract the path of light incident along the second optical axis C2 in the direction of a third optical axis C3. The optical path changing unit 700 may include members capable of refraction or reflection of light. For example, the first optical path changing unit 710 and the second optical path changing unit 720 may each be configured as a prism or a reflector. The optical path changing unit 700 may be disposed in the housing 801. For example, the first optical path changing unit 710 may be disposed on one end of the housing 801, and the second optical path changing unit 720 may be disposed on the other end of the housing 801. However, the arrangement position of the optical path changing unit 700 is not limited to one end and the other end of the housing 801. The second optical path changing unit 720 may be configured to refract light incident along the second optical axis C2 in a direction intersecting the first optical axis C1 and the second optical axis C2. For example, the path (the third optical axis C3) of light refracted by the second optical path changing unit 720 may be configured to intersect the first optical axis C1 and the second optical axis C2.

The camera module 14 may further include a configuration for detecting a movement position of the lens module 101. For example, the camera module 14 may further include a magnet 610, and sensing sensors 620 and 630, and the magnet 610 may be disposed on the lens module 101. For example, the magnet 610 may be disposed on a side surface of the lens module 101. The sensing sensors 620 and 630 may be disposed in a position in which the magnetic field generated from the magnet 610 may be easily detected. For example, the sensing sensors 620 and 630 may be disposed on the bracket 600 or one surface of the housing 801 facing the side of the lens module 101. The sensing sensors 620 and 630 may be disposed at a predetermined interval. For example, two sensing sensors 620 and 630 may be spaced apart in the second optical axis C2 direction. The distance between the sensing sensors 620 and 630 may be substantially equal to the maximum driving displacement of the lens module 101.

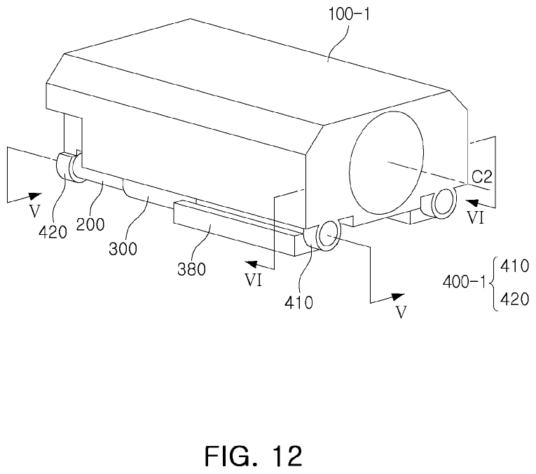

Next, an arrangement structure between the lens module 101 and the driving unit will be described with reference to FIGS. 12 to 14.

The lens module 101 may move along the second optical axis C2 by the driving unit. The driving unit may include the driving magnet 200 and the driving coil 300. However, the configuration of the driving unit is not limited to the driving magnet 200 and the driving coil 300. For example, the driving unit may further include the coil support member 380 and the oilless bearing 500.

The driving magnet 200 may be fixed to the lens module 101. For example, the driving magnet 200 may be fixed to one side of the lens module 101 by the coupling unit 400-1. The coupling unit 400-1 may include the first coupling portion 410 and the second coupling portion 420. The first coupling portion 410 is configured to fix one end of the driving magnet 200 to one side of the lens module 101, and the second coupling portion 420 is configured to fix the other end of the driving magnet 200 to the other side of the lens module 101. On the other hand, although the driving magnet 200 is illustrated as being disposed below the lens module 101 in FIG. 12, the driving magnet 200 may also be disposed on an upper portion or a side surface of the lens module 101. In addition, although the two driving magnets 200 are illustrated to be disposed on the same side of the lens module 101 in the accompanying drawings, three or more driving magnets 200 may also be disposed on different sides of the lens module 101.

The driving magnet 200 may be formed to be elongated in the longitudinal direction of the lens module 101 or the second optical axis C2 direction. For example, the length Lm of the driving magnet 200 may be substantially the same as the length of the lens module 101. However, the length Lm of the driving magnet 200 is not necessarily the same as the length of the lens module 101. For example, the length Lm of the driving magnet 200 may be greater than the length of the lens module 101 or less than the length of the lens module 101.

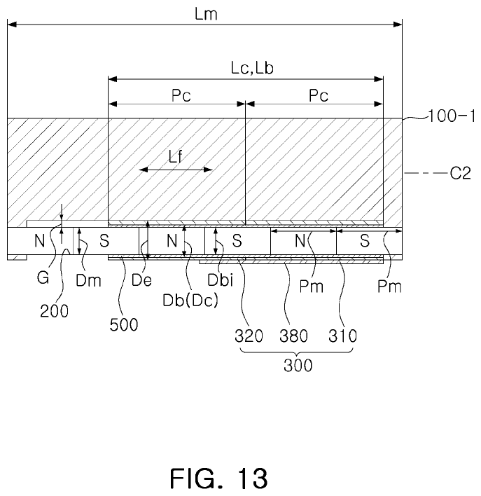

The driving magnet 200 may be disposed so as not to contact the side surface of the lens module 101. For example, a portion of the driving magnet 200 excluding both ends thereof may form a predetermined gap G with the side surface of the lens module 101, as illustrated in FIG. 13.

The driving coil 300 may be configured to interact with the driving magnet 200 to form driving force. In more detail, the driving coil 300 may be configured to interact with a magnetic field generated in the circumferential direction of the driving magnet 200. For example, the driving coil 300 may be configured in a cylindrical shape to accommodate the driving magnet 200 therein.

The driving coil 300 may be disposed on one side of the lens module 101. For example, the driving coil 300 may be disposed on one side of the lens module 101 while being coupled to the driving magnet 200. The driving coil 300 may be configured not to contact the lens module 101. For example, an outer diameter De of the driving coil 300 may satisfy the conditional expression (De−Dm)/2<G. Accordingly, the driving coil 300 may not interfere with the movement of the lens module 101.

The driving coil 300 may have a predetermined length. For example, the length Lc of the driving coil 300 may be less than the length Lm of the driving magnet 200. A length deviation Lm−Lc between the driving magnet 200 and the driving coil 300 may have a predetermined relationship with the maximum movement displacement Lf of the lens module 101. For example, the length deviation Lm-Lc between the driving magnet 200 and the driving coil 300 may be greater than the maximum movement displacement Lf of the lens module 101.

The driving coil 300 may include a plurality of coil bundles 310 and 320. For example, the driving coil 300 may include the first coil bundle 310 and the second coil bundle 320. However, the number of coil bundles constituting the driving coil 300 is not limited to two. For example, the driving coil 300 may also include three or more coil bundles. The coil bundles 310 and 320 may be formed to face one or more poles of the driving magnet 200. For example, the length Pc of the coil bundles 310 and 320 may be equal to the length Pm of the N pole or S pole of the driving magnet 200 or may be greater than the length Pm of the N pole or S pole of the driving magnet 200. The first coil bundle 310 and the second coil bundle 320 may be configured to interact with the driving magnet 200 to generate the driving force in the same direction.

The driving coil 300 configured as described above may be firmly fixed to one surface of the housing 801 or the bracket 600 by the coil support member 380. The coil support member 380 may be formed of an insulating material to prevent the current of the driving coil 300 from leaking to the outside of the coil support member 380. However, the material of the coil support member 380 is not limited to an insulating material. The driving coil 300 may be electrically connected to a controller of the camera module 14. For example, the driving coil 300 may be electrically connected to the controller of the camera module 14 or the substrate 900 by a separate flexible substrate or other connecting member.

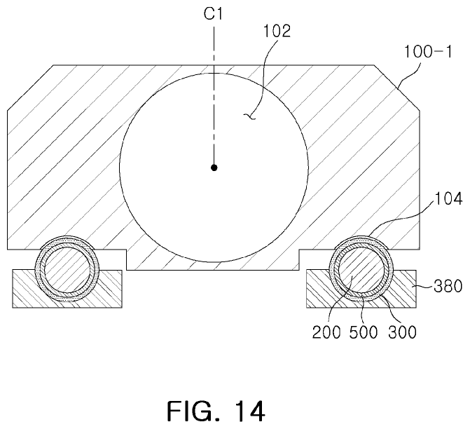

The camera module 14 may include an element for significantly reducing frictional resistance between the driving magnet 200 and the driving coil 300. For example, the camera module 14 may include the oilless bearing 500 disposed between the driving magnet 200 and the driving coil 300 as illustrated in FIGS. 13 and 14. The oilless bearing 500 may be formed to have substantially the same length Lb as that of the driving coil 300. However, the length Lb of the oilless bearing 500 is not necessarily the same as the length Lc of the driving coil 300. An outer diameter Db of the oilless bearing 500 may be substantially the same as the inner diameter Dc of the driving coil 300, and an inner diameter Dbi of the oilless bearing 500 may be substantially the same as the diameter Dm of the driving magnet 200.

The lens module 101 may be configured such that the height in the direction of the first optical axis C1 is significantly reduced as illustrated in FIG. 14. In more detail, the lens module 101 may be configured to significantly reduce interference between a lens mounting unit 102 and a driving unit mounting unit 104. For example, the driving unit mounting unit 104 may be formed on both sides of the lens mounting unit in a horizontal direction with respect to the lens mounting unit 102. In addition, the driving unit mounting unit 104 may be formed in a concave shape such that the driving magnet 200 and the driving coil 300 may be disposed as close to each other as possible.

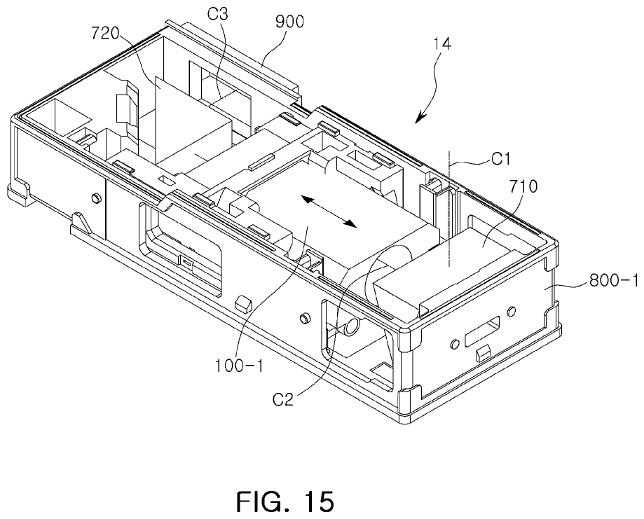

The camera module 14 according to this example may be formed in the form illustrated in FIG. 15. The camera module 14 may include the lens module 101 that is movable to enable autofocusing or focus magnification adjustment, and may include a plurality of optical path changing units 710 and 720 for optical path conversion. In addition, the camera module 14 may include the substrate 900 on which the image sensor 910, which is capable of converting an optical signal into an electrical signal, is mounted.

The camera module 14 may be able to adjust focus and adjust focus magnification. For example, the camera module 14 may adjust the focus (AF function) by moving the lens module 101 with a relatively low displacement range. As another example, the camera module 14 may move the lens module 101 with a high displacement range to adjust the focus (a zoom function). The displacement range of the lens module 100 may be widely adjusted by the above-described driving magnet 200 and driving coil 300. For example, the movement displacement of the lens module 101 may be easily adjusted within the extension range of the driving magnet 200. Accordingly, in the camera module 14 according to this example, the autofocusing and the focus magnification adjustment of the camera module 14 may be easily performed through one driving unit.

In addition, since the camera module 14 may change the optical path in the length or width or height direction of the camera module 14 through the plurality of optical path changing units 710 and 720, the camera module 14 may be thinned and miniaturized.

As set forth above, according to examples disclosed herein, linear mobility of a lens module may be improved. In addition, a high-magnification camera module may be implemented.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A camera module, comprising:
a lens module including one or more lenses disposed along an optical axis;
a driving magnet disposed on the lens module and extending along the optical axis; and
a driving coil configured to receive the driving magnet therein, and to interact with the driving magnet to drive the lens module in an optical axis direction.

2. The camera module of claim 1, wherein the lens module further comprises a coupling unit configured to be coupled to the driving magnet.

3. The camera module of claim 2, wherein the coupling unit comprises:
a first coupling portion coupled to one end of the driving magnet; and
a second coupling portion coupled to another end of the driving magnet.

4. The camera module of claim 1, wherein a length of the driving magnet in the optical axis direction is greater than a length of the driving coil in the optical axis direction.

5. The camera module of claim 1, wherein the driving magnet is configured in a form of a rod.

6. The camera module of claim 1, wherein a first polarity and a second polarity are alternately formed in the driving magnet, along the optical axis direction.

7. The camera module of claim 1, further comprising an oilless bearing configured to reduce friction between the driving magnet and the coil member.

8. The camera module of claim 1, wherein the driving coil comprises:
a first coil bundle configured to interact with a first portion of the driving magnet through a first current signal; and
a second coil bundle disposed adjacent to the first coil bundle and configured to interact with a second portion of the driving magnet through a second current signal.

9. The camera module of claim 1, wherein the driving coil comprises:
a first coil bundle configured to interact with a first region of the driving magnet through a first current signal to generate driving force in a first direction; and
a second coil bundle disposed adjacent to the first coil bundle, and configured to interact with a second region of the driving magnet by the first current signal to generate driving force in the first direction.

10. The camera module of claim 1, wherein the driving coil comprises:
a first coil bundle configured to interact with a first portion of the driving magnet through a first current signal;
a second coil bundle disposed adjacent to the first coil bundle and configured to interact with a second portion of the driving magnet through a second current signal; and
a third coil bundle disposed adjacent to the second coil bundle and configured to interact with a third portion of the driving magnet by a third current signal.

11. The camera module of claim 1, wherein the driving magnet comprises a plurality of driving magnets and the driving coil comprises a plurality of driving coils, and
wherein the plurality of driving magnets and the plurality of driving coils are disposed in a circularly symmetrical shape with respect to the optical axis.

12. The camera module of claim 1, further comprising a coil support member configured to fix the driving coil to a housing.

13. The camera module of claim 1, further comprising an optical path changing unit disposed on an object side of the lens module and configured to change an optical path of incident light.

14. A camera module, comprising:
a lens module including one or more lenses;
a driving magnet having a rod shape, coupled to the lens module, and having a first polarity and a second polarity alternately formed in an optical axis direction; and
a driving coil disposed to face a circumferential surface of the driving magnet at a predetermined distance, and configured to provide driving force to drive the lens module through interacting with the driving magnet.

15. The camera module of claim 14, further comprising an optical path changing unit disposed on an object side of the lens module.

16. The camera module of claim 14, wherein the driving coil comprises coil bundles disposed adjacent to each other in the optical axis direction, and configured to respectively interact with different portions of the driving magnet.

17. The camera module of claim 14, wherein the driving coil has a trough shape having a radius of curvature substantially the same as a shape of the circumferential surface of the driving magnet.
